(19) United States
(12) Patent Application Publication
(10) Pub. No.: US 2010/0100258 A1
(43) Pub. Date: Apr. 22, 2010

(54) Method of Ergonomically Selecting a Reference Course/Radial for the Guidance of an Aircraft

(75) Inventors: Elias Bitar, Tournefeuille (FR); Christophe Caillaud, Blagnac (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, Neuilly-Sur-Seine (FR)

(21) Appl. No.: 12/558,183

(22) Filed: Sep. 11, 2009

(30) Foreign Application Priority Data
Sep. 19, 2008 (FR) 08 05150

(51) Int. Cl. G06F 19/00

(52) U.S. Cl. 701/3

(57) ABSTRACT

The invention relates to a method and an associated device making it possible to avoid guidance command input errors by the crew. Since the course and the radial are linked by different relationships depending on whether the aircraft is approaching or moving away from a point, the procedures from air traffic control may be given either in course or in radial, and since the FMS system can also require the input of one of the two values, the number of possible different combination creates a situation of ambiguity that is prejudicial to the safety of the flight. To resolve this problem, the invention proposes a systematic display in text mode and/or in graphic mode of the input datum (course or radial) and of the other for verification by the crew.

### CROSS-REFERENCE TO RELATED APPLICATIONS

This application claims priority of Application No. 08 05150 filed in France on Sep. 19, 2008, the entire contents of which is incorporated herein in its entirety.

### FIELD OF THE INVENTION

The invention belongs to the field of onboard flight management systems on aircraft. More specifically, it applies to the guidance module whose function is to transmit the procedures from the pilot to the aeroplane system.

### BACKGROUND OF THE INVENTION

The ergonomics of these systems are particularly critical to flight safety. In practice, the increasing automation since the beginning of the 1980s has led the crew to use mainly the electronic systems and to use the primary piloting controls of the aircraft less and less. This trend has been emphasized since the beginning of the 1990s with the use of onboard flight management systems (FMS) becoming widespread. A flight management system comprises various functional components that enable the crew to programme a flight from a navigation database. The system then calculates a lateral and vertical trajectory making it possible to reach the destination of the flight plan based on the characteristics of the aeroplane and the data supplied by the crew and the environment of the system. The positioning and guidance functions collaborate for the aircraft to remain on the trajectory. The crew however remains responsible for the progress of the flight. It is therefore essential that it receive from the various subsystems the right information presented unambiguously enabling the crew to make and execute the right navigation decisions at the right moment. To obtain this result, the designers of the subsystems pay increasing attention to the relevance and clarity of the information presented to the crew and the manner in which said information is presented, as well as to the tools that are available to it to confirm that the commands input are valid.

Progress is ongoing on the subject but, among the problems that are not resolved by the prior art, there is the one posed by the programming of a convergent or divergent trajectory according to a course or a radial given relative to a point, which is a conventional function of an FMS described in the ARINC 702A-3 standard “Advanced Flight Management Computer System”, and which is very widely used notably in the approach phase. One example is the approach axis capture as described in the PANS-OPS (Procedures for Air Navigation Services—Aircraft Operations, which set the instrument approach procedures and the departure procedures and which are summarized in the document published by the International Civil Aviation Organization—ICAO—8168 Volume I) for parallel approaches. In this case, the crew can receive a procedure from the traffic controller of the destination airport expressed either by course or by radial that must be communicated to the aeroplane system in one of these two modes which will be the only one displayed on the control screen. Now, the course is equal to the radial when diverging from a point but equal to the radial plus 180° when approaching toward the point. This combination (external procedure mode; input mode; conversion between modes) creates a problem likely to seriously compromise the safety of the flight because if the pilot makes a mistake on the procedure that he inputs, the aeroplane might be led to make a half-turn. The present invention resolves this problem.

### SUMMARY OF THE INVENTION

To this end, the invention discloses a dialogue method between a pilot and the flight management system of an aircraft comprising a step for inputting a first datum chosen from the group of course and radial types and, when the two data in the group are of different types, a step for calculating the second datum of the group, further comprising a step for displaying roughly simultaneously the two data of the group when they are of different types.

Advantageously, the step for displaying comprises a graphic mode in which the direction of the aeroplane is represented differently depending on whether it is converging towards a point and/or it is moving away therefrom.

Advantageously, the step for inputting the first datum is optionally performed by an action belonging to the group of the following actions: action on a keyboard, action on the graphic representation of the direction of the aeroplane, action on a thumbwheel.

Advantageously, the display step comprises a text mode in which the designations of the radial interceptions are different depending on whether it is an approaching interception or a distancing interception.

Advantageously, the second datum is displayed roughly in the vicinity of the first input datum.

The invention also discloses a dialogue interface between a pilot and the flight management system of an aircraft comprising an input apparatus chosen from the group comprising keyboard, thumbwheel, mouse, for inputting a first datum chosen from the group of the course and radial types and, when the two data of the group are different, a function for calculating the second datum of the group, further comprising a function for displaying the two data of the group roughly simultaneously when they are of different types.

The main benefit of the present invention is that it offers feedback to the pilot concerning the procedure that he has entered into the system as well as the instruction that the aeroplane will actually follow, and all before the procedure is actually activated.

### BRIEF DESCRIPTION OF THE DRAWINGS

The invention will be better understood, and its various characteristics and benefits will emerge, from the following description of a number of exemplary embodiments, and its appended figures in which:

FIGS. 1.1 and 1.2 explain the course-radial conversion mode respectively in the case of convergence towards a point and in the case of divergence from a point;

FIG. 2 represents an aeroplane approach and landing phase;

FIGS. 3.1 and 3.2 represent the graphic display of the course and of the radial respectively in a case of approaching and diverging from a waypoint according to an embodiment of the invention;

FIG. 4 represents the textual display of the same procedures according to an embodiment of the invention.

### DETAILED DESCRIPTION

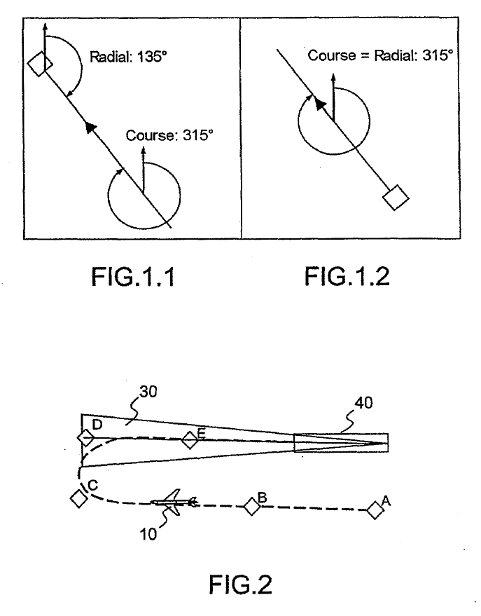

FIGS. 1.1 and 1.2 explain the course-radial conversion mode respectively in the case of convergence towards a point and in the case of divergence from a point.

Until the operational use of absolute positioning means such as GNSS, trajectory programming was based on radio-navigation beacons, for example a VOR (very high frequency omnidirectional range) beacon, possibly associated with distance measuring equipment (DME). It was done by radial lines regardless of whether the aircraft was converging toward or diverging from said beacon. The radials are position-plotting lines of which the angle relative to magnetic north in the clockwise direction is measured. These position lines are not oriented according to the direction of movement of the aeroplane on the line. An aircraft that is approaching a beacon and an aircraft that is diverging following opposite headings have the same radial. On the other hand, if the waypoint is not a beacon (for example an airport runway), the programming is done by course. The course is the angle measured in the clockwise direction between magnetic north and the aeroplane heading. Therefore, an aeroplane that is diverging from the waypoint will have a course 180° greater than that of an aeroplane that is approaching thereto following the same direction passing through the point. Now, air traffic controllers may give radial interception instructions even when the waypoint is not a radiofrequency beacon and the operator must make the conversion before inputting the procedure into the FMS if it offers an interface limited to course interception.

FIG. 2 represents an approach and landing phase of an aeroplane and illustrates the problem created by the coexistence of these two procedure modes.

An aircraft 10 follows a route passing through points A, B towards waypoints C and D to enter into the capture beam 30 of the approach axis D, E of the landing runway 40. In the situation illustrated, the aeroplane has been guided to the heading by the operator by following the clearances from air traffic control. If the procedure is to intercept the course of the runway approach means towards the final approach point, the natural procedure is to input a course procedure towards this point. If the interface does not propose this programming means, the operator must enter the value of the opposite direction (corresponding to a radial) then check the result on another flight plan display page when executing the command. In practice, the system converts this reference trajectory into a manoeuvre with termination condition (otherwise known as a leg, these legs are defined in the ARINC 424 standard).

In an approach case, the programmed leg is a CF (course to fix). In a comparable situation, air traffic control may send clearance to the radial interception operator (generally to a radio-navigation beacon). If the reference point is not a radio-navigation beacon, the operator cannot check the result on the flight plan display page when executing the command. In practice, a CF-type manoeuvre will be flown observing the calculated course value (radial input plus 180°) and not the programmed radial value. When diverging from a point, the course followed by the aircraft is equal to the radial starting from this point. The system converts this reference trajectory into an FM (fix to manual, or course from a fixed point to a manual termination) leg.

Since this kind of manoeuvre is performed more in the destination runway approach phase, the operator has already been subjected to a high work load and can easily mix up the scenarios. The situation can have critical consequences because the post-checking capabilities are low: the result of the programming actually carried out by the operator is presented on the navigation display following the calculation of the trajectory of the new flight plan. Now, a 180° error may be detected only when the aeroplane's servocontrol function is actually engaged. In practice, when the new flight plan is in the system, a trajectory is calculated and presented to the crew, but if the aeroplane is too close to the radial, the guidance will be directly engaged. Obviously, the risk of the aircraft actually making a half-turn is limited by the fact that the coupling between flight plan and automatic pilot is disengaged if the deviation between aeroplane heading and trajectory course is greater than 160°. However, this does not settle all the scenarios likely to occur, like when the capture angle is between 30° and 45°. To resolve these problems uniformly in all cases, including those that can compromise flight safety, the invention therefore provides ways of lifting ambiguity that are suited to the display mode used with the programming: either the navigation display which is in graphic mode or the multifunction display which is in text mode.

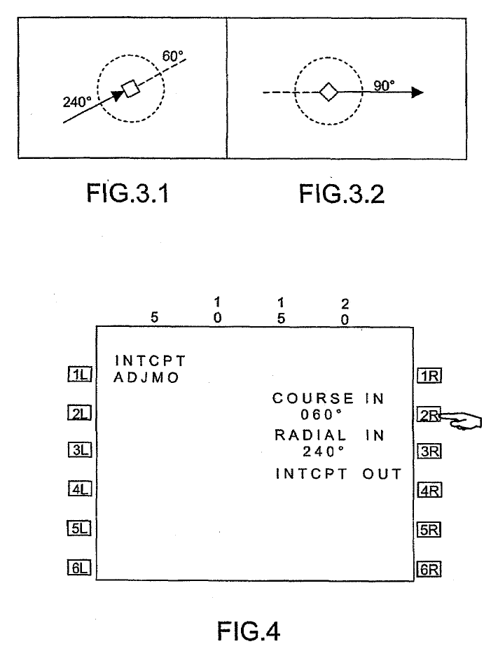

FIGS. 3.1 and 3.2 represent the graphic display of the course and of the radial respectively in a waypoint approach and divergence case according to an embodiment of the invention.

Eliminating ambiguity in graphic mode entails making clearly apparent both the fact that the situation is a waypoint approach or divergence situation and the difference or the equality of the two course and radial angles. In a preferred embodiment of the invention, the approach/divergence difference is underscored by three symbolic representations:
the course that is actually flown (approaching or diverging from the waypoint) is represented for example as a solid line;
the solid line ends with an arrow head next to the rhombus symbol which represents the waypoint in an approach scenario and at the opposite end in a divergence scenario;
the course that is not flown (forward of the waypoint in an approach scenario and backward of the waypoint in a divergence scenario) is represented for example by a dotted line.

The graphic representations can have a number of variants provided that they fulfil the same technical function, namely clearly differentiating approach and divergence situations.

Furthermore, when the values of the course and the radial are different (by 180°) they both appear on the graphic navigation display. Such is the case of FIG. 3.1 which represents an approach scenario with a course of 240° and a radial of 60°. In the case of FIG. 3.2, the course and the radial both have a value equal to 90°.

In the case of FIG. 3.1, if the operator enters the procedure in the form of a 60° radial interception, the system calculates the course of the CF leg which must be inserted into the flight plan to allow the trajectory observing the convergent radial to be calculated. In the case illustrated, the course is equal to 240°. In the state of the art, the numerical values are not displayed on the parameter input interface, the course being represented only graphically. According to the invention, the radial value input by the operator and the course value are both represented both symbolically as explained above and numerically. The numerical course and radial values are respectively attached to the leg flown (continuous line in the figure) and to the leg not flown which is situated on the other side of the waypoint (broken line in the figure). The procedure can also be input as a course. In this case, the radial is not directly involved but is nevertheless displayed.

To input one of the two data, there are a number of possible means; the course or the radial can be input:
by its numerical value on the keyboard;
by rotating the operator thumbwheel which varies an initially displayed value;
by using the arrows on the keyboard or any other interface means with the navigation display, to rotate the direction of the course or of the radial represented by the line.

In the example of FIG. 3.2, course and radial are equal. In the exemplary embodiment illustrated, it has been chosen to display only a single value given that the two are equal.

When the programming is done by the multifunction display, and therefore in text mode, it is also important to distinguish the approach and divergence scenarios.

FIG. 4 represents the textual display of the same procedures according to an embodiment of the invention.

According to the invention, this elimination of ambiguity in text mode is provided by the vocabulary. In the case of an approach, the direction of the manoeuvre, IN, is attached to the expressions COURSE and RADIAL. In the case of a divergence, in the embodiment illustrated, it has been chosen to use the same word INTERCEPT for the course and the radial since they are equal. It would be possible to envisage including the two expressions COURSE OUT and RADIAL OUT with the same value.

The invention requires no hardware modification to the flight management system. Some calculation and display loops, certain symbols and certain names displayed for the fields of the flight database must be modified. Those skilled in the art will nevertheless be able to make these modifications based on the information in this description.

The examples described hereinabove are given as illustrations of embodiments of the invention. They in no way limit the scope of the invention which is defined by the following claims.

1. Dialogue method between a pilot and the flight management system of an aircraft comprising a step for inputting a first datum chosen from the group of course and radial types and, when the two data in the group are of different types, a step for calculating the second datum of the group, further comprising a step for displaying roughly simultaneously the two data of the group when they are of different types.

2. Dialogue method according to claim 1, wherein the step for displaying comprises a graphic mode in which the direction of the aeroplane is represented differently depending on whether it is converging towards a point and/or it is moving away therefrom.

3. Dialogue method according to claim 2, wherein the step for inputting the first datum is optionally performed by an action belonging to the group of the following actions: action on a keyboard, action on the graphic representation of the direction of the aeroplane, action on a thumbwheel.

4. Dialogue method according to claim 1, wherein the step for displaying comprises a text mode in which the designations of the radial interceptions are different depending on whether it is an approaching interception or a distancing interception.

5. Dialogue method according to claim 4, wherein the second datum is displayed roughly in the vicinity of the first input datum.

6. Dialogue interface between a pilot and the flight management system of an aircraft comprising an input apparatus chosen from the group comprising keyboard, thumbwheel, mouse, for inputting a first datum chosen from the group of the course and radial types and, when the two data of the group are different, a function for calculating the second datum of the group, further comprising a function for displaying the two data of the group roughly simultaneously when they are of different types.
